(19) United States
(12) Patent Application Publication
(10) Pub. No.: US 2015/0136087 A1
(43) Pub. Date: May 21, 2015

(54) FUEL SUPPLYING DEVICE

(71) Applicant: AISAN KOGYO KABUSHIKI KAISHA, Aichi-ken (JP)

(72) Inventor: Masaki Ikeya, Aichi-ken (JP)

(73) Assignee: AISAN KOGYO KABUSHIKI KAISHA, Aichi-ken (JP)

(21) Appl. No.: 14/547,841

(22) Filed: Nov. 19, 2014

(30) Foreign Application Priority Data
Nov. 19, 2013 (JP) 2013-238669

(51) Int. Cl. F02M 57/00; F02M 41/16

(52) U.S. Cl. CPC F02M 57/005; F02M 41/16
USPC 123/456

(57) ABSTRACT

A fuel supplying device supplying fuel from a fuel tank to combustion device may comprise a fuel pipe configured to communicate the fuel tank with a delivery pipe of the combustion device, and a sensor unit configured to detect a property of the fuel. The fuel pipe may branch into a plurality of branch pipes including a first branch pipe and a second branch pipe at an intermediate position between the fuel tank and the combustion device. The sensor unit may comprise a plurality of sensors including a first sensor and a second sensor. The first sensor may be disposed in the first branch pipe and configured to detect the property of the fuel within the first branch pipe. The second sensor may be disposed in the second branch pipe and configured to detect the property of the fuel within the second branch pipe.

### CROSS-REFERENCE TO RELATED APPLICATION

This application claims priority to Japanese Patent Application No. 2013-238669 filed on Nov. 19, 2013, the contents of which are hereby incorporated by reference into the present application.

### TECHNICAL FIELD

The present application discloses a fuel supplying device supplying a fuel from a fuel tank to a combustion device.

### DESCRIPTION OF RELATED ART

Japanese Patent Application Publication, No. 2006-214415 A discloses a technology for injecting a fuel to an engine. The fuel is supplied from a fuel tank to a fuel supply pipe. The fuel supply pipe branches into two branch fuel supply pipes on the way to the engine. One of the branch fuel supply pipes (hereinafter referred to as “cylinder supply pipe”) is configured to supply the fuel to a cylinder delivery pipe, and the other one of the branch fuel supply pipes (hereinafter referred to as “intake supply pipe”) is configured to supply the fuel to an intake delivery pipe. Connected to the cylinder delivery pipe is a cylinder injector, and connected to the intake delivery pipe is an intake passage injector. An ECU is configured to inject the fuel to the engine by controlling the cylinder injector and the intake passage injector. The ECU is configured to determine, on the basis of a concentration of alcohol in the fuel as measured by an alcohol concentration sensor, amounts of fuel that are to be injected by the cylinder injector and the intake passage injector, respectively.

### SUMMARY

In order to appropriately supply, to a combustion device configured to burn fuel, the fuel that is to be used by the combustion device, it is advisable to grasp a property of the fuel that is supplied to the combustion device. A technology that a property of fuel that is supplied to a combustion device may be appropriately detected is provided herein.

The present application discloses a fuel supplying device supplying fuel from a fuel tank to a combustion device. The fuel supplying device may comprise a fuel pipe configured to communicate the fuel tank with a delivery pipe of the combustion device, and a sensor unit configured to detect a property of the fuel. The fuel pipe may branch into a plurality of branch pipes including a first branch pipe and a second branch pipe at an intermediate position between the fuel tank and the combustion device. The sensor unit may comprise a plurality of sensors including a first sensor and a second sensor. The first sensor may be disposed in the first branch pipe and configured to detect the property of the fuel within the first branch pipe. The second sensor may be disposed in the second branch pipe and configured to detect the property of the fuel within the second branch pipe.

According to the foregoing configuration, the property of the fuel within each of the first and second branch pipes may be detected. There is a case where the property of the fuel within the first branch pipe and the property of the fuel within the second branch pipe are different from each other. For example, there is a case where fuel having a property that is different from a property of the fuel within the fuel tank is supplied to the fuel tank. In this case, when the fuel is supplied from the fuel pipe to the combustion device, fresh fuel having a property that is different from a property of the fuel within the fuel pipe is freshly supplied to the fuel pipe. When an amount of the fuel within the first branch pipe that is supplied to the combustion device is larger than an amount of the fuel within the second branch pipe that is supplied to the combustion device, such a situation arises that whereas the fuel within the first branch pipe is replaced by the fresh fuel, the fuel within the second branch pipe is not replaced with the fresh fuel.

In such a situation, the foregoing configuration makes it possible to appropriately detect a property of the fuel that is supplied to the combustion device, as the foregoing configuration makes it possible to detect the property of the fuel within each of the first and second branch pipes.

The present application discloses a sensor device for a fuel supplying device supplying fuel from a fuel tank to a combustion device. The fuel supplying device may comprise a fuel pipe configured to communicate the fuel tank with a delivery pipe of the combustion device. The fuel pipe may branch into a plurality of branch pipes including a first branch pipe and a second branch pipe at an intermediate position between the fuel tank and the burning device. The sensor device may comprise a plurality of sensors including a first sensor and a second sensor. The first sensor may be disposed in the first branch pipe and configured to detect the property of the fuel within the first branch pipe. The second sensor may he disposed in the second branch pipe and configured to detect the property of the fuel within the second branch pipe.

According to the foregoing configuration, the property of the fuel within each of the first and second branch pipes may be detected. Therefore, a property of the fuel that is supplied to the combustion device may be appropriately detected.

The present application discloses a supplying control system configured to controlling a supply of fuel of a combustion equipment. The supplying control system may comprise the above fuel supplying device, a plurality of injectors configured to inject the fuel supplied from the fuel supplying device to the combustion equipment, each of the plurality of injectors injecting the fuel supplied from each of the plurality of branch pipes, and a controller configured to control an injecting quantity of each of the plurality of injectors based on detection results of the plurality of the sensors.

According to this configuration, the controller may control an injecting quantity of each of the plurality of injectors based on an appropriate property of the fuel that is supplied to the combustion device.

### BRIEF DESCRIPTION OF THE DRAWINGS

FIG. 1 shows a configuration of a system for supplying fuel. FIG. 2 shows a configuration of a sensor of a first embodiment. FIG. 3 shows a figure for explaining a process of a sensor device and ECU. FIG. 4 shows a configuration of a sensor of a modification of the first embodiment. FIG. 5 shows a configuration of a sensor of a second embodiment. FIG. 6 shows a configuration of a sensor of a modification of the second embodiment. FIG. 7 shows a configuration of a sensor of a third embodiment.

### DETAILED DESCRIPTION

Some features of embodiments described herein will be listed. Notably, technical features described herein are each independent technical element, and exhibit technical usefulness thereof solely or in combinations.

(Feature 1)

The fuel supplying device may comprise a calculator configured to calculate the property of the fuel using detection results of the plurality of sensors. The calculator may comprise a processing circuit configured to execute a first calculation process and a second calculation process. The first calculation process may calculate the property of the fuel within the first branch pipe using a detection result of the first sensor. The second calculation process may calculate the property of the fuel within the second branch pipe using a detection result of the second sensor. This configuration eliminates the need to separately disposing a processing circuit for the first sensor and a processing circuit for the second sensor.

(Feature 2)

The processing circuit may execute the first calculation process at a different timing from a timing when the second calculation process is executed. This configuration eliminates the need for the processing circuit to execute the first calculation process and the second calculation process at the same time. This makes it possible to simplify the circuit configuration of the processing circuit.

(Feature 3)

The calculator may be configured to compare the detection results of the plurality of sensors and output a comparison result to an external device. This configuration allows the external device to detect an abnormality occurring in the sensor unit based on the comparison result.

(Feature 4)

The plurality of sensors may include a third sensor disposed between a branching point of the fuel pipe and the fuel tank. The third sensor may be configured to detect the property of the fuel between the branching point of the fuel pipe and the fuel tank. This configuration makes it possible to detect the property of the fuel within the fuel pipe between the branching point and the fuel tank.

(Feature 5)

The calculator may be configured to calculate the property of the fuel within the first branch pipe for each of predetermined fuel quantity units, and store the properties of the fuel from the first sensor to the delivery pipe in a memory in the predetermined fuel quantity units. This configuration makes it possible to divide the fuel within the first branch pipe into a plurality of zones and store the property of the fuel within each of the zones in the memory. As a result of this, even when the property of the fuel within the first branch pipe changes in the middle of the first branch pipe, the property of the fuel before the change and the property of the fuel after the change can be appropriately detected.

(Feature 6)

The first sensor may have a pair of electrodes. At least one electrode of the pair of electrodes may be integrally formed with the first branch pipe. This configuration makes it possible to downsize and simplify the first branch pipe.

(Feature 7)

The fuel supplying device may comprise a storage communicating with the first branch pipe and configured to store the fuel. The first sensor may be stored in the storage. This configuration makes it possible to dispose the first sensor by causing the storage to communicate with the first branch pipe.

(Feature 8)

The first sensor may be stored in the first branch pipe. This configuration makes it possible to dispose the first sensor in the first branch pipe.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved fuel supplying devices, sensor devices and supplying control systems, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

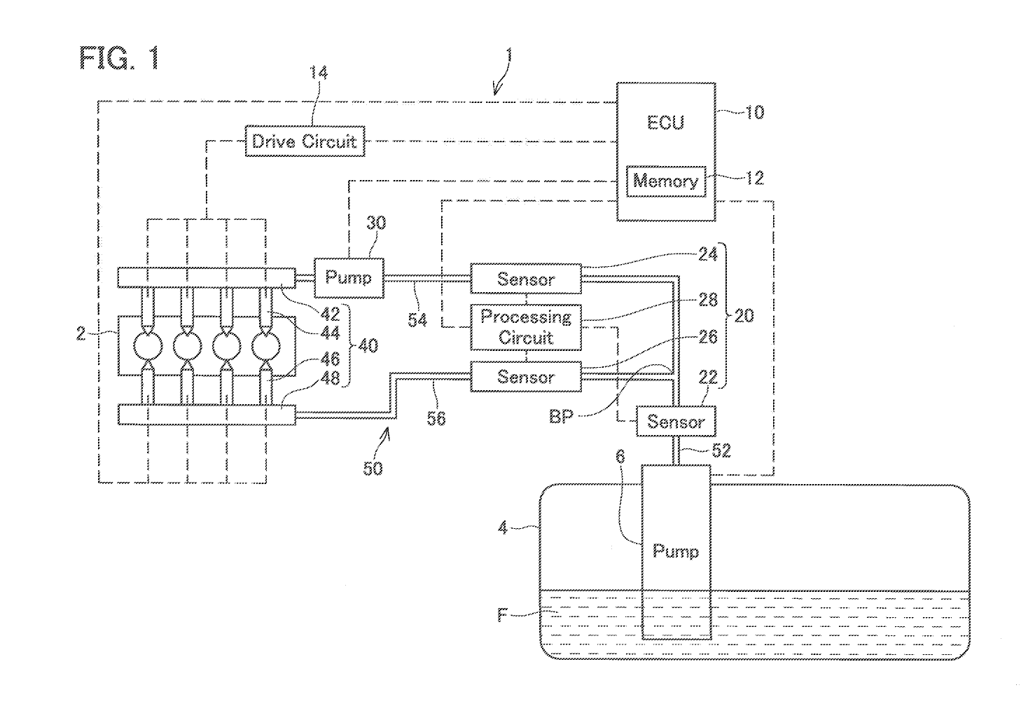

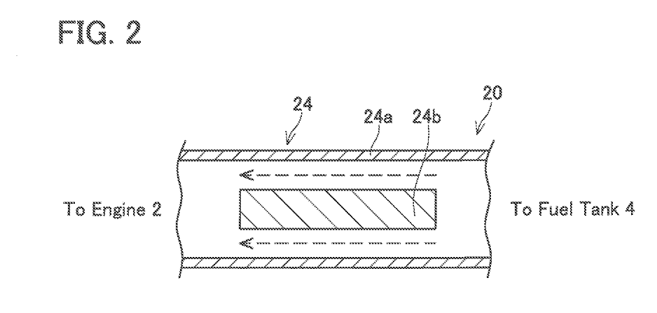

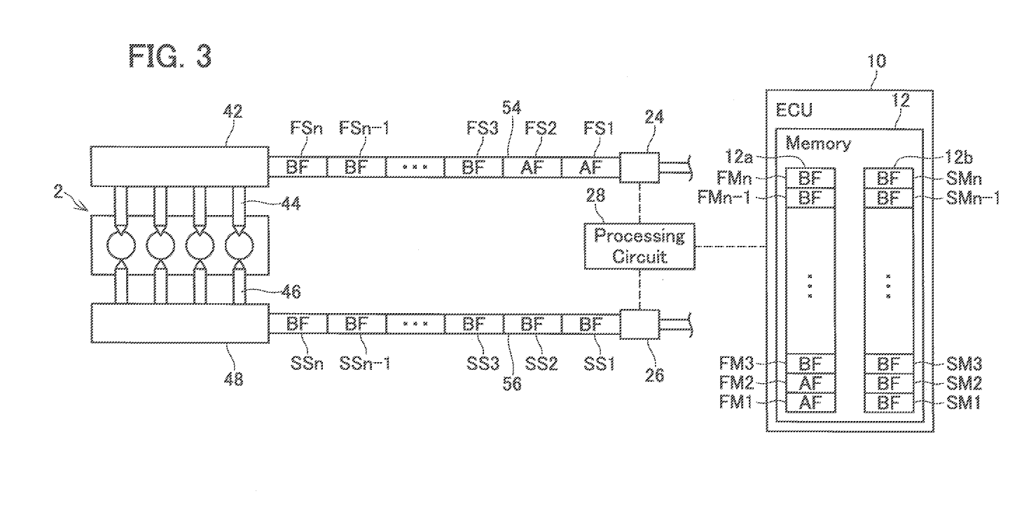

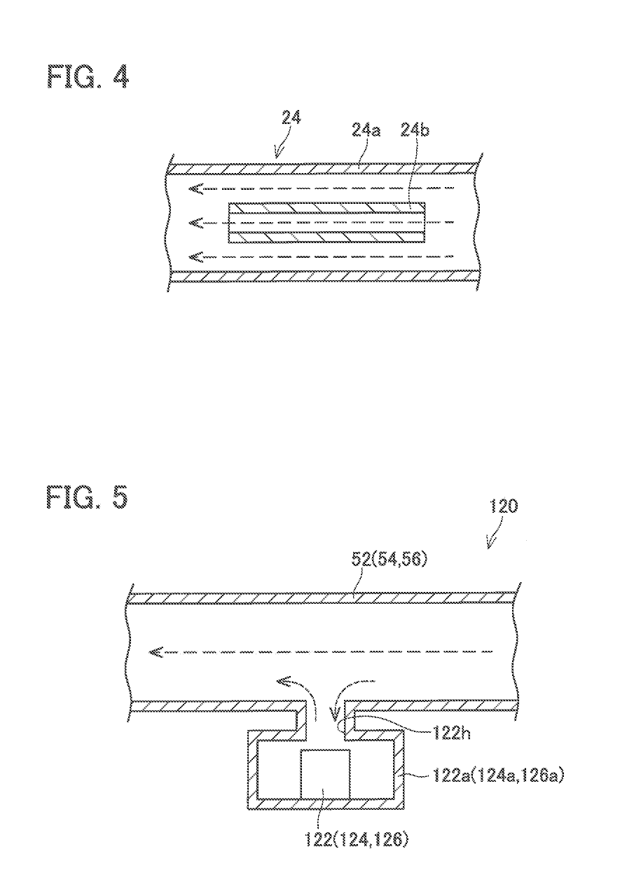

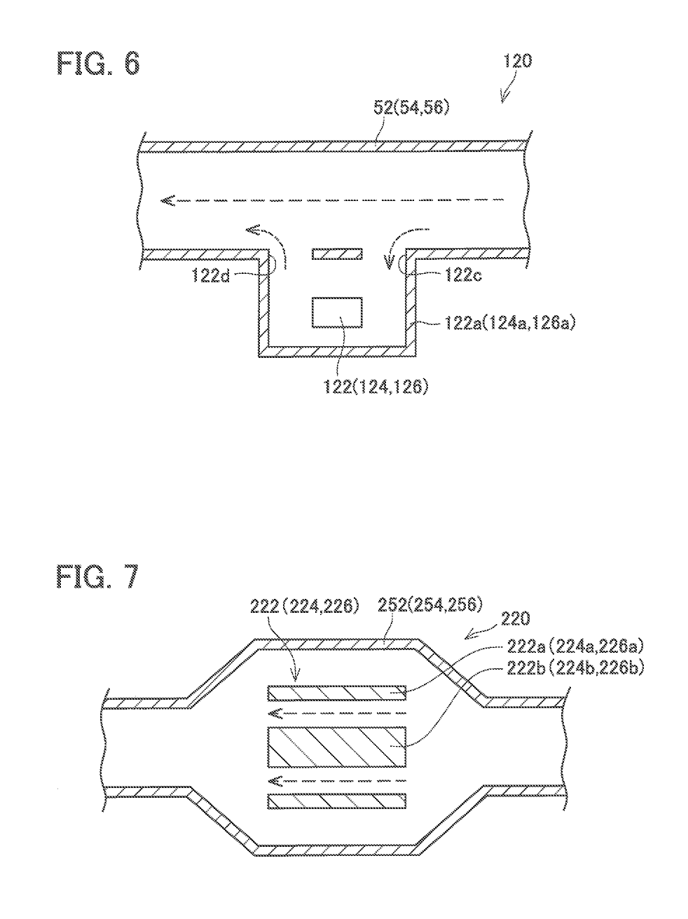

A system for supplying fuel of a first embodiment as shown in FIG. 1 is configured to supply fuel to an engine 7 of an automobile. Disposed in the system for supplying fuel is a fuel supplying system 1 for supplying fuel F within a fuel tank 4 to the engine 2.

The engine 2 is a single-cylinder or multicylinder (in FIG. 1, four-cylinder) engine. The fuel tank 4 stores fuel F whose ethanol concentration ranges from 0% (i.e., the fuel composed solely of gasoline) to 100% (i.e., the fuel composed solely of ethanol).

(Configuration of the Fuel Supplying System 1)

The fuel supplying system 1 is configured to supply, to the engine 2, fuel discharged from a fuel pump 6 in the fuel tank 4. The fuel supplying system 1 includes an ECU (which stands for “electronic control unit”) 10, a sensor unit 20, a pump 30, an injection mechanism 40, and a supply pipe 50.

(Configuration of the Supply Pipe 50)

The supply pipe 50 is a pipe through which fuel within the fuel tank 4 is supplied to the injection mechanism 40. The supply pipe 50 includes a main pipe 52 and two branch pipes 54 and 56. One end of the main pipe 52 is connected to a discharge port of the fuel pump 6. The other end of the main pipe 52 branches into the two branch pipes 54 and 56 at a branching point BP. Each of the branch pipes 54 and 56 extends from the branching point BP to the injection mechanism 40.

The pump 30 is disposed at an intermediate position on the branch pipe 54. The pump 30 pressurizes fuel within the branch pipe 54 and discharges the pressurized fuel toward the injection mechanism 40.

(Configuration of the Injection Mechanism 40)

The injection mechanism 40 includes delivery pipes 42 and 48, a plurality of (in FIG. 1, four) cylinder injectors 44, and a plurality of (in FIG. 1, four) port injectors 46. The delivery pipe 42 is connected to the branch pipe 54 and connected to each of the plurality of cylinder injectors 44. The delivery pipe 42 is configured to supply the fuel within the branch pipe 54 to each of the plurality of cylinder injectors 44. The delivery pipe 48 is connected to the branch pipe 56 and connected to each of the plurality of port injectors 46. The delivery pipe 48 is configured to supply fuel within the branch pipe 56 to each of the plurality of port injectors 46.

The cylinder injectors 44 are injection devices for directly injecting fuel into a combustion chamber of the engine 2. The cylinder injectors 44 are configured to inject the fuel supplied from the delivery pipe 42. The port injectors 46 are injection devices for injecting fuel to an intake port of the engine 2. Connected to the intake port of the engine 2 is an intake passage (not illustrated) such as an intake manifold.

(Configuration of the Sensor unit 20)

The sensor unit 20 includes three sensors 22, 24, and 26 and a processing circuit 28. The sensor 24 is used for detecting an ethanol concentration of the fuel within the branch pipe 54. As shown in FIG. 2, the sensor 24 includes an inner electrode 24b and an outer electrode 24a. The outer electrode 24a is in the shape of a circular tube. The outer electrode 24a is formed integrally with the branch pipe 54, and constitutes part of the branch pipe 54. The inner electrode 24b is in the shape of a circular column. The inner electrode 24b is disposed coaxially with the center axis of the outer electrode 24a. A side surface of the inner electrode 24b faces an inner circumferential surface of the outer electrode 24a. That is, a portion of the branch pipe 54 that faces the side surface of the inner electrode 24b corresponds to the outer electrode 24a.

The sensor 26 is used for detecting an ethanol concentration of the fuel within the branch pipe 56. The sensor 26 has the same components as those of the sensor 24. The sensor 22 is used for detecting an ethanol concentration of fuel within the main pipe 52. The sensor 22 has the same components as those of the sensor 24. This configuration makes it possible to utilize the supply pipe 50 to constitute one electrode of each of the electrode pairs of the sensors 22, 24, and 26 (namely, the outer electrodes of the sensors 22, 24, and 26). This makes it possible to simplify the configuration of each of the sensors 22, 24, and 26.

The processing circuit 28 is a circuit for detecting an ethanol concentration of fuel. The processing circuit 28 is mounted with an IC (which stands for “integrated circuit”). The processing circuit 28 is supplied with electric power from a battery (not illustrated). The processing circuit 28 generates a signal (i.e., AC voltage) of a predetermined frequency (e.g. 10 Hz to 3 MHz) or a pulse signal. The processing circuit 28 supplies the signal thus generated. to each of the sensors 22, 24, and 26 in sequence and receives a signal from each of the sensors 22, 24, and 26. The processing circuit 28 transmits the detected ethanol concentration to the ECU 10. A process that the processing circuit 28 executes for detecting the ethanol concentration will be described in detail later.

(Configuration of the ECU 10)

The ECU 10 controls the sensor unit 20, the pump 30, the injection mechanism 40, and the fuel pump 6. The ECU 10 is constituted by a microcomputer or the like, and includes a memory 12 constituted by ROM, RAM, or the like. The ECU 10 is electrically connected to the sensor unit 20, the pump 30, the injection mechanism 40, and the fuel pump 6. It should be noted that the automobile may have its ECU 10 divided into a plurality of ECUs 10 that are placed at different positions, respectively.

(Operation of the Fuel Supplying System 1)

Next, operation of the fuel supplying apparatus 1 is described. The ECU 10 controls the fuel pump 6 in accordance with an operation that a driver performs on the automobile (e.g. an operation for starting the engine 2 or an operation on the gas pedal) or the like. Specifically, the ECU 10 outputs, to the fuel pump 6, a signal for driving the fuel pump 6. This causes the fuel pump 6 to he driven so the fuel F within the fuel tank 4 is pressurized by the fuel pump 6 and supplied to the supply pipe 50.

The fuel supplied to the supply pipe 50 flows into the branch pipe 54 or the branch pipe 56 through the main pipe 52. The ECU 10 drives the pump 30 to adjust the pressure of the fuel that is supplied from the branch pipe 54 to the delivery pipe 42. The fuel within the branch pipe 54 is pressurized by the pump 30 and then supplied to the delivery pipe 42. Meanwhile, the fuel within the branch pipe 56 is supplied to the delivery pipe 48.

The ECU 10 controls a drive circuit 14 to actuate the cylinder injectors 44. Upon receiving, from the ECU 10, an instruction (i.e. a signal) for actuating the cylinder injectors 44, the drive circuit 14 supplies, to the cylinder injectors 44, the signal for actuating the cylinder injectors 44, whereby the cylinder injectors 44 are actuated so that the fuel supplied from the delivery pipe 42 to the cylinder injectors 44 is injected into the combustion chamber of the engine 2.

Further, the ECU 10 supplies, to the port injectors 46, a signal for actuating the port injectors 46, whereby the port injectors 46 are actuated so that the fuel supplied from the delivery pipe 48 to the port injectors 46 is injected to the intake port of the engine 2.

While the automobile is being driven, the processing circuit 28 regularly detects the ethanol concentration of the fuel within the main pipe 52 using the sensor 22. Specifically, the processing circuit 28 supplies a signal to the sensor 22. In the sensor 22, the electrode 22a is supplied with the signal and the electrode 22b is grounded. As a result of this, charges are stored on the electrode pair constituted by the electrodes 22a and 22b of the sensor 22, so that a capacitance is generated. A gap between the electrodes 22a and 22b is filled with the fuel within the main pipe 52. For this reason, the capacitance of the electrode pair constituted by the electrodes 22a and 22b varies in a correlated way with the dielectric constant of the fuel. Since gasoline and ethanol are different in dielectric constant from each other, the dielectric constant of the fuel changes according to the ethanol concentration.

The signal that is supplied to the sensor 22 varies in a correlated way with the capacitance of the electrode pair constituted by the electrodes 22a and 22b, i.e. the dielectric constant of the fuel. The processing circuit 28 is mounted with a circuit for converting the signal that is supplied to the sensor 22 into the dielectric constant of the fuel. Further, the processing circuit 28 has stored therein a database indicating a relationship between the dielectric constant of the fuel and the concentration of ethanol in the fuel as specified in advance by experiment or by analysis. The processing circuit 28 detects the concentration of ethanol in the fuel from the dielectric constant of the fuel with reference to the database. The processing circuit 28 outputs, to the ECU 10, the ethanol concentration thus detected and information indicating that the ethanol concentration thus detected is an ethanol concentration of the fuel within the main pipe 52. The ECU 10 stores the ethanol concentration thus obtained as an ethanol concentration of the fuel within the main pipe 52 in the memory 12. The ECU 10 updates the concentration of the fuel within the main pipe 52 in the memory 12 every time it obtains an ethanol concentration of the fuel within the main pipe 52 from the processing circuit 28.

Further, the processing circuit 28 detects concentrations of ethanol in the fuel within the branch pipes 54 and 56 using the sensors 24 and 26, respectively, and outputs detection results to the ECU 10. The processing circuit 28 alternately and repeatedly executes the process calculation process) of detecting the ethanol concentration using the sensor 24 and the process (i.e., calculation process) of detecting the ethanol concentration using the sensor 26. Upon obtaining ethanol concentrations from the processing circuit 28, the ECU 10 stores the ethanol concentrations in the memory 12. This process of the processing circuit 28 and the ECU 10 from the detection of concentrations of ethanol in the fuel within the branch pipes 54 and 56 to the storage of the ethanol concentrations in the memory 12 is described with reference to FIG. 3.

The processing circuit 28 detects, using the sensor 24, the concentration of ethanol in a portion of the fuel within the branch pipe 54 that is located in the sensor 24. Since the processing circuit 28 alternately and repeatedly executes the process of detecting the ethanol concentration using the sensor 24 and the process of detecting the ethanol concentration using the sensor 26, the process of detecting the ethanol concentration using the sensor 24 is intermittently and repeatedly executed. When fuel is injected from the cylinder injectors 44 to the engine 2, the fuel within the branch pipe 54 flows toward the engine 2 by the amount injected. This causes the fuel located in the sensor 24 to be replaced. That is, in the sensor 24, every time fuel is injected from the cylinder injectors 44 to the engine 2, a portion of fuel that serves as a target of detection is replaced with another portion of fuel that serves as the target of detection. The processing circuit 28 stores detected ethanol concentrations cumulatively in a memory of the processing circuit 28.

The ECU 10 integrates the amount of fuel that is injected from the cylinder injectors 44 to the engine 2. For example, the ECU 10 calculates, using an actuation time (i.e. valve-opening time) of the cylinder injectors 44, the amount of fuel that is injected from the cylinder injectors 44. When the integrated amount of fuel that is injected from the cylinder injectors 44 (ix, the integrated amount of fuel thus calculated) reaches a predetermined amount, the ECU 10 outputs, to the processing circuit 28, an instruction. signal for the processing circuit 28 to output the concentration of ethanol in fuel within the branch pipe 54 to the ECU 10. The branch pipe 54 is divided into n sections FS1 to FSn (where n is an integer of 2 or greater), and the predetermined amount is equal to the amount of fuel that is stored in each of these sections FS1 to FSn. In addition, the amounts of fuel that arc stored in these sections FS1 to FSn are identical with one another.

Upon obtaining the instruction signal, the processing circuit 28 calculates an average value of ethanol concentrations cumulatively stored in the memory of the processing circuit 28. According to this, for example, an average value of concentrations of ethanol in fuel present in the section FS1 of the branch pipe 54 is calculated. The processing circuit 28 outputs, to the ECU 10, the average value of ethanol concentrations thus calculated and information indicating that the ethanol concentrations are the ethanol concentrations of the fuel within the branch pipe 54.

Upon obtaining the average value of ethanol concentrations from the processing circuit 28, the ECU 10 stores it in a first storage region 12a of the memory 12. The processing circuit 28 repeatedly executes the process of detecting ethanol concentrations, the process of calculating the average value of ethanol concentrations, and the process of outputting the average value of ethanol concentrations. Meanwhile, the ECU 10 repeatedly executes the process of integrating the amount of injection, the process of outputting an ethanol concentration output instruction, the process of obtaining the average value of ethanol concentrations, and the process of storing the average value of ethanol concentrations.

As a result of this, n average values of ethanol concentrations corresponding to the n sections FS1 to FSn of the branch pipe 54 are cumulatively stored in memory regions FM1 to FMn of the first storage region 12a, respectively. Every time the predetermined amount of fuel is injected from the cylinder injectors 44, the ECU 10 obtains an average value of ethanol concentrations from the processing circuit 28, erases the average value in the memory region FMn that is stored earliest of the n average values of ethanol concentrations stored in the first storage region 12a, moves the average values stored in the sections FM1 to FMn−1 to the sections FM2 to FMn, respectively, and stores the newly obtained average value of ethanol concentrations in the memory region FM1.

By executing processes which are similar to those described above, the processing circuit 28 and the ECU 10 executes the process of detecting ethanol concentrations within the branch pipe 56 using the sensor 26. As a result of this, n average values of ethanol concentrations corresponding to n sections SS1 to SSn of the branch pipe 56 are cumulatively stored in sections SM1 to SMn of a second storage region 12b of the memory 12, respectively.

Gasoline and ethanol are different for example in vaporization characteristic and burning characteristic from each other. The ECU 10 changes the operation of the cylinder injectors 44 and the port injectors 46 according to the ethanol concentration of fuel that is injected to the engine 2. Specifically, the ECU 10 controls the cylinder injectors 44 with reference to the ethanol concentration which, of the ethanol concentrations stored in the first storage region 12a, is stored in the section FMn (i.e. the ethanol concentration stored earliest in the first storage region 12a), and the port injectors 46 with reference to the ethanol concentration which, of the ethanol concentration which, of the ethanol concentrations stored in the second storage region 12b, is stored in the section SMn (i.e. the ethanol concentration stored earliest in the second storage region 12b).

Further, the processing circuit 28 compares ethanol concentrations obtained using detection results of the sensors 22 and 26, Furthermore, the processing circuit 28 compares ethanol concentrations obtained using detection results of the sensors 24 and 26. When, as a result of the comparison, the difference between ethanol concentrations is greater than a predetermined value, the processing circuit 28 outputs a predetermined signal to the ECU 10. As a result of this, the ECU 10 determines that an abnormality (i.e. a situation where appropriate detection is impossible due to the breaking of a wire, a foreign matter in a sensor, or the like) has occurred in the sensor unit 20. The ECU 10 notifies (e.g. by making a sound or performing a display) the driver that an abnormality has occurred in the sensor unit 20. This configuration allows the driver to know that an abnormality has occurred in the sensor unit 20.

(Effects of the Present Embodiment)

The fuel supplying system 1 of the present embodiment is configured such that even in such a situation as below, for example, the ECU 10 can appropriately grasp the ethanol concentration of fuel that is supplied to the engine 2 and thereby control the amount of fuel that is to be supplied to the engine 2. When fuel AF differing in ethanol concentration from fuel BF already stored in the fuel tank 4 is freshly supplied to the fuel tank 4, the ethanol concentration of the fuel BF within the supply pipe 50 is different from the ethanol concentration of the fuel AF within the fuel tank 4. Moreover, in a situation where the engine 2 should be driven in a high-rotation and high-load state by the driver's operation, the ECU 10 utilizes the drive circuit 14 so that a large amount of fuel is supplied from the cylinder injectors 44 to the engine 2. As a result of this, as shown in FIG. 3, the fuel AF differing in ethanol concentration from the fuel BF already present in the branch pipe 54 is supplied to the sections FS1 and FS2 of the branch pipe 54.

In this situation, the sensor unit 20 can detect the ethanol concentration of the fuel within each of the branch pipes 54 and 56 and can therefore appropriately detect the ethanol concentration of the fuel that is supplied to the engine 2. For this reason, the ECU 10 can supply an appropriate amount of fuel to the engine 2.

The processing circuit 28 executes the process of detecting the ethanol concentration using the sensor 24, the process of detecting the ethanol concentration using the sensor 26, and the process of detecting the ethanol concentration using the sensor 22. This configuration eliminates the need to separately dispose a processing circuit for each of the sensors 22, 24, and 26.

The processing circuit 28 alternately executes the process of detecting the ethanol concentration using the sensor 24 and the process of detecting the ethanol concentration using the sensor 26. Further, in executing the process of detecting the ethanol concentration using the sensor 22, the processing circuit 28 stops the process of detecting the ethanol concentration using the sensor 24 and the process of detecting the ethanol concentration using the sensor 26. The processing circuit 28 does not need to concurrently execute detection processes using two sensors. As a result of this, the circuit configuration of the processing circuit 28 can be simplified.

(Modification of the First Embodiment)

The sensors 22, 24, and 26 are not limited to the configuration described above (see FIG. 2). As shown in FIG. 4, for example, the inner electrode 24b may be in the shape of a circular tube. This configuration allows fuel to pass through the inside of the inner electrode 24b and therefore smoothly flow through the supply pipe 50. Further, the outer electrode 24a is not limited to the shape of a circular tube, but may be in the shape of a polygonal tube, an elliptical tube, or the like. Further, the inner electrode 24b is not limited to the shape of the circular column or the circular tube, but may be in the shape of a polygonal tube or column, an elliptical tube or column, or the like.

### Second Embodiment

In a second embodiment, a sensor unit 120 is different in configuration from the sensor unit 20 of the first embodiment. Points of difference from the first embodiment are described with reference to FIG. 5. The sensor unit 120 of the second embodiment includes sensors 122, 124, and 126, storage cases 122a, 124a, and 126a, and a processing circuit 28 (not illustrated in FIG. 5; see FIG. 1). The sensor 122 includes a pair of flat electrodes. The sensor 122 is housed in the storage case 122a. The storage case 122a has a communication opening 122b communicating with the main pipe 52. The communication opening 122b allows fuel to flow from the main pipe 52 into the storage case 122a and allows fuel to flow out of the storage case 122a to the main pipe 52.

Each of the sensors 124 and 126 has the same components as those of the sensor 122. As with the storage case 122a, the storage case 124a houses the sensor 124 and communicates with the branch pipe 54. As with the storage case 122a, the storage case 126a houses the sensor 126 and communicates with the branch pipe 56. This configuration makes it possible to dispose the sensors 122, 124, and 126 by causing the storage cases 122a, 124a, and 126a to communicate with the supply pipe 50.

(Modification of the Second Embodiment)

The storage ease 122a (124a, 126a) is not limited to the configuration described above (see FIG. 5). As shown in FIG. 6, for example, the storage case 122a (124a, 126a) may have communication openings 122c and 122d communicating with the main pipe 52. The communication opening 122c may allow fuel to flow from the main pipe 52 into the storage case 122a. The communication opening 122d may allow fuel to flow out of the storage case 122a to the main pipe 52.

### Third Embodiment

In a third embodiment, a sensor unit 220 is different in configuration from the sensor unit 20 of the first embodiment, and a configuration of pipes 252, 254, and 256 is different from the configuration of the pipes 52, 54, and 56 of the first embodiment. Points of difference from the first embodiment are described with reference to FIG. 7. The sensor unit 220 of the third embodiment include sensors 222, 224, and 226, storage cases 222a, 224a, and 226a, and a processing circuit 28 (not illustrated in FIG. 7; see FIG. 1).

The sensor 222 includes an outer electrode 222a in the shape of a circular tube and an inner electrode 222b in the shape of a circular column. Each of the electrodes 222a and 222b are disposed on the same axis as the main pipe 252. The inner electrode 222b is placed in the outer electrode 222a. The length of the inner electrode 222b along its axis is the same as the length of the outer electrode 222a along its axis. Formed between the inner electrode 222b and the outer electrode 222a is a gap that fuel within the main pipe 252 enters. The sensor 224 includes an inner electrode 224b and an outer electrode 224a that are the same in configuration as the inner electrode 222b and the outer electrode 222a. The sensor 226 includes an inner electrode 226b and an outer electrode 226a that are the same in configuration as the inner electrode 222b and the outer electrode 222a.

The main pipe 252 houses the sensor 222. The pipe diameter of the main pipe 252 is larger in a part thereof in which the sensor 222 is disposed than in other parts thereof. As with the main pipe 252, the pipe diameter of the main pipe 254 is larger in a part thereof where the sensor 224 is disposed than in other parts thereof, and the pipe diameter of the main pipe 256 is larger in a part thereof where the sensor 226 is disposed than in other parts thereof.

(Modification)

(1) In each of the embodiments described above, the supply pipe 50 includes the two branch pipes 54 and 56. Alternatively, the supply pipe 50 may include three or more branch pipes. In this case, the supply pipe 50 may branch into the three or more branch pipes at a single branching point BP or may branch at a plurality of branching points. The sensor unit 20 may have sensors disposed in the three or more branch sensors, respectively.

(2) In each of the embodiments described above, the sensor unit 20 has a single sensor 22 disposed in the main pipe 52, a single sensor 24 disposed in the branch pipe 54, and a single sensor 26 disposed in the branch pipe 56. Alternatively, the sensor unit 20 may have two or more sensors disposed each of the branch pipes 54 and 56.

(3) In each of the embodiments described above, the sensor unit 20 or the like is used for detecting an ethanol concentration of fuel. Alternatively, the sensor unit 20 or the like may be used for detecting a property of fuel that can be detected using the dielectric constant and conductivity of fuel, such as the degree of deterioration of fuel and the temperature of fuel. Further, the sensor unit 20 or the like may be used for detecting a property of alcohol fuel other than ethanol. In this modification, the degree of deterioration and the temperature of fuel are examples of the “property”.

(4) The components of the sensor 22 and the like are not limited to those of the embodiments described above. For example, the sensor may include a pair of comblike electrodes disposed on a substrate.

(5) In each of the embodiments described above, the sensors 22 (or 222) are disposed in the main pipes 52 (or 252) of the supply pipe 50, respectively. Alternatively, it is not necessary to dispose sensors in the main pipes 52 (or 252). In this case, the processing circuit 28 may compare ethanol concentrations detected by the sensor 22 and the like disposed in the branch pipe 52 and the like, respectively, and when, as a result of the comparison, the difference between ethanol concentrations is greater than a predetermined value, the processing circuit 28 may output, to the ECU 10, a signal indicating that an abnormality is occurring in the sensor unit 20 or the like.

(6) The ECU 10 may replace the processing circuit 28 to execute some of the processes that the processing circuit 28 executes, e.g. the process of calculating ethanol concentrations. In this modification, the processing circuit 28 may output the capacitance and the like of the sensor 22 and the like to the ECU 10. Generally speaking, the sensor unit 20 may output a value associated with a property of fuel to the ECU 10. The sensor unit 20 of this modification, too, may be encompassed in the “sensor unit configured to detect a property of the fuel”.

(7) In each of the embodiments described above, the fuel pump 6 is disposed inside of the fuel tank 4. Alternatively, the fuel pump 6 may be disposed outside of the fuel tank 4. In this case, the supply pipe 50 may further include a pipe that extends from an admission port of the fuel pump 6 into the fuel tank 4. In other words, the fuel pump 6 may be disposed at an intermediate position on the supply pipe 50 communicating the fuel tank 4 and the delivery pipes 42 and 48 disposed in the engine 2. The supply pipe 50 of this modification is an example of the “fuel pipe”.

1. A fuel supplying device supplying fuel from a fuel tank to a combustion device, the fuel supplying device comprising:
a fuel pipe configured to communicate the fuel tank with a delivery pipe of the combustion device; and
a sensor unit configured to detect a property of the fuel, wherein
the fuel pipe branches into a plurality of branch pipes including a first branch pipe and a second branch pipe at an intermediate position between the fuel tank and the combustion device, and
the sensor unit comprises a plurality of sensors including a first sensor and a second sensor, the first sensor disposed in the first branch pipe and configured to detect the property of the fuel within the first branch pipe, and the second sensor disposed in the second branch pipe and configured to detect the property of the fuel within the second branch pipe.

2. The fuel supplying device as in claim 1, further comprising
a calculator configured to calculate the property of the fuel using detection results of the plurality of sensors, wherein
the calculator comprises a processing circuit configured to execute a first calculation process and a second calculation process, the first calculation process calculating the property of the fuel within the first branch pipe using a detection result of the first sensor, and the second calculation process calculating the property of the fuel within the second branch pipe using a detection result of the second sensor.

3. The fuel supplying device as in claim 2, wherein
the processing circuit executes the first calculation process at a different timing from a timing when the second calculation process is executed.

4. The fuel supplying device as in claim 2, Wherein
the calculator is configured to compare the detection results of the plurality of sensors and output a comparison result to an external device.

5. The fuel supplying device as in claim 2, wherein
the plurality of sensors includes a third sensor disposed between a branching point of the fuel pipe and the fuel tank, and configured to detect the property of the fuel between the branching point of the fuel pipe and the fuel tank.

6. The fuel supplying device as in claim 2, wherein
the calculator is configured to:
calculate the property of the fuel e first branch pipe for each of a predetermined fuel quantity units, and
store the properties of the fuel from the first sensor to the delivery pipe in a memory in the predetermined fuel quantity units.

7. The fuel supplying device as in claim 1, wherein
the first sensor has a pair of electrodes, and
at least one electrode of the pair of electrodes is integrally formed with the first branch pipe.

8. The fuel supplying device as in claim 1, further comprising:
a storage communicating with the first branch pipe and configured to store the fuel, wherein
the first sensor is stored in the storage.

9. The fuel supplying device as in claim 1, wherein
the first sensor is stored in the first branch pipe.

10. A sensor device for a fuel supplying device supplying fuel from a fuel tank to a combustion device, the fuel supplying device comprising a fuel pipe configured to communicate the fuel tank with a delivery pipe of the combustion device, the fuel pipe branching into a plurality of branch pipes including a first branch pipe and a second branch pipe at an intermediate position between the fuel tank and the burning device, the sensor device comprising:
a plurality of sensors including a first sensor and a second sensor, the first sensor disposed in the first branch pipe and configured to detect the property of the fuel within the first branch pipe, and the second sensor disposed in the second branch pipe and configured to detect the property of the fuel within the second branch pipe.

11. A supplying control system configured to controlling a supply of fuel of a combustion equipment, the supplying control system comprising:
a fuel supplying device as in claim 1;
a plurality of injectors configured to inject the fuel supplied from the fuel supplying device to the combustion equipment, each of the plurality of injectors injecting the fuel supplied from each of the plurality of branch pipes; and
a controller configured to control an injecting quantity of each of the plurality of injectors based on detection results of the plurality of the sensors.
